(19) United States
(12) Patent Application Publication
(10) Pub. No.: US 2011/0047034 A1
(43) Pub. Date: Feb. 24, 2011

(54) SYSTEM AND METHOD FOR PROCESSING PRINT JOBS

(75) Inventors: Amarnath Purohit, Rochester, NY (US); Araz Khachatrian, Pittsford, NY (US); Lewis S. Snow, La Crescenta, CA (US)

Correspondence Address: Xerox Corporation (CDFS), 445 Broad Hollow Rd.-Suite 420, Melville, NY, 11747, US

(73) Assignee: Xerox Corporation, Norwalk, CT (US)

(21) Appl. No.: 12/543,063

(22) Filed: Aug. 18, 2009

(51) Int. Cl. G06Q 10/00; G06Q 30/00; G06F 3/048

(52) U.S. Cl. 705/14.69; 715/764; 705/1.1; 705/14.4; 705/37

(57) ABSTRACT

A computer implemented document-processing system and related method includes a receiving component, a capabilities analysis component, an authorization component and a calculating component. The receiving component receives a campaign-specifications data structure including one or more job specifications. One of the job specifications is associated with a job type selected from a direct mail campaign catalog, a direct mail campaign advertising and a direct mail non-printable service. The capabilities analysis component selects a set of capable entries from a database of vendors such that each selected entry corresponds to a vendor capable of performing one or more jobs of a campaign as operatively specified by one or more job specifications of the campaign-specifications data structure. The authorization component authorizes a set of entries from the database of vendors that conform to a predetermined set of criteria. The calculating component electronically calculates a plurality of prices corresponding to the campaign-specifications data structure. Each of the plurality of prices is operatively associated with one entry of the authorized set of entries and/or one entry of the selected set of capable entries.

### CROSS-REFERENCE TO RELATED APPLICATIONS

This application is related to U.S. patent application Ser. No. ______ filed on Aug. 18, 2009 titled “System and Method for Allocating Content of Electronic Documents” by Purohit et al.; U.S. patent application Ser. No. 12/427,001 titled “Campaign Management of Direct Mail” by Snow et al.; and U.S. patent application Ser. No. 12/426,978 titled “Automated Direct Mail Procurement System” by Snow et al.; the entire contents of the three applications are incorporated herein by reference.

### BACKGROUND

1. Technical Field

The present disclosure is generally related to print job processing, and more particularly, to a system and method for delegating print jobs among a plurality of vendors.

2. Description of Related Art

Reverse auctions are commonly used to minimize the purchase price of items. In this style of auction, where the role of the buyer and the seller are reversed, the seller engages in competitive bidding in which items are offered for sale at a bid price of the seller's choosing. The buyer can select among the bids. Some reverse auction rules require the buyer to select the lowest bid. By engaging in a reverse auction, also referred to as a procurement auction, a buyer can sometimes purchase items at a lower price than are available through more typically used commercial channels. These reverse auctions can place downward pricing pressure on the sellers to cut costs, increase efficiency and/or minimize waste. Additionally, such auctions are sometimes used to facilitate business-to-business transactions.

Some reverse auctions are organized by a broker (sometimes referred to as a market maker) using a marketplace. The buyers and/or sellers contract with the broker to agree to be bound to the marketplace rules and procedures. The broker also provides consulting services and other market facilitating tasks. Some of the tasks the broker may perform include: organizing the marketplace rules and procedures, culling a list of capable sellers, authoring sellers, training sellers, interfacing the sellers into electronic aspects of the marketplace, organizing the auction, and providing auction data services to buyers and sellers. Some of the broker services sometimes include data services involving communication among sellers, buyers, and the marketplace. For example, the sellers and buyers may communicate with the marketplace using Extensible Markup Language (referred to as “XML”).

Advertising campaigns generally use a variety of advertising techniques. Purchases for items involving these techniques may be obtained in a variety of ways, including by outsourcing. During 2007, marketers in the U.S. spent a total of $55.3 billion in direct mail advertisements, driving $686.7 billion in sales. By 2012, it is anticipated that American businesses will spend $61.7 billion on direct mail advertisements. In comparison, $1.2 billion will be spent on e-mail marketing and $39.7 billion will be spent on Internet (non-e-mail) marketing. In 2012, 27% of marketing budgets will be allocated to direct mail advertisements.

### SUMMARY

In an embodiment of the present disclosure, a document-processing system includes a process and a computer-readable storage medium. The computer-readable storage medium is in communication with the processor and includes one or more programming instructions for: (1) electronically receiving a campaign-specifications data structure including at least one job specification, wherein the at least one job specification is associated with a job type selected from a catalog, an advertising campaign and a mail related service; (2) selecting a set of entries from a database, wherein each selected entry corresponds to a vendor capable of performing a job as operatively specified by the at least one job specification of the campaign-specifications data structure; (3) authorizing one or more of the selected set of capable entries in accordance with a predetermined set of criteria; and (4) calculating a plurality of prices corresponding to the campaign-specifications data structure, wherein each of the plurality of prices is operatively associated with at least one of the one or more of the selected set of capable entries.

The one or more programming instructions may further include generating a workflow corresponding to the campaign-specification data structure. The workflow may include a first job unit corresponding to a first job of the at least one job specification of the campaign-specifications data structure. The workflow may include a second job unit corresponding to a second job of the at least one job specification of the campaign-specifications data structure. The first and second job units may be operatively associated with different entries in the database of vendors.

The system may include: (1) a workflow optimization user interface configured to receive input from a user to control the generation of the at least one workflow; and/or (2) an awards component to generate an award campaign data structure corresponding to the campaign-specification data structure, wherein the awards campaign data structure includes at least one awarded job unit corresponding to the at least one job specification.

The catalog may include a direct mail campaign catalog. The direct mail campaign catalog may include one of a plurality of job types. The job types may include a card job type, an envelope job type, a brochure job type, and a poster job type. In another embodiment of the present disclosure, a system for processing advertisement campaign requests includes a receiving component, a capabilities analysis component, an authorization component, and a calculating component. The receiving component, the capabilities analysis component, the authorization component and the calculating component include a first, second, third and fourth buffer, respectively. A single memory, or several memories, may contain the first, second, third and fourth buffers.

The receiving component electronically receives a campaign-specifications data structure including one or more job specifications. The receiving component stores the campaign-specifications data structure in the first buffer. A job specification is associated with a job type selected from a direct mail campaign catalog, direct mail campaign advertising and direct mail non-printable services. The campaign-specifications data structure may include two job specifications being associated with different job types.

The capabilities analysis component operatively and electronically receives the campaign-specifications data structure from the first buffer of the receiving component. The capabilities analysis component selects a set of capable entries from a database of vendors and stores the selected set of capable entries in the second buffer. Each selected entry corresponds to a vendor capable of performing a first job of a campaign as operatively specified by a job specification of the campaign-specifications data structure.

The authorization component authorizes a set of entries corresponding to the database of vendors conforming to a predetermined set of criteria. The authorized set of entries is stored in the third buffer and is selected from the selected set of capable entries and/or from the entries of the database of vendors.

The calculating component electronically calculates a plurality of prices corresponding to the campaign-specifications data structure. The fourth buffer stores the plurality of prices and each of the plurality of prices is operatively associated with one of the authorized set of entries and/or one of the selected set of capable entries. Additionally or alternatively, the system includes a comparison component to determine the lowest price from the plurality of prices associated with the authorized set of entries. The lowest price is operatively flagged in the fourth buffer.

In an embodiment of the present disclosure, each of the plurality of prices is operatively associated with only one of the authorized set of entries. And in another embodiment, the authorized set of entries is selected by said authorization component for authorization from only the set of capable entries.

In yet another embodiment of the present disclosure, the system further includes a interface component. The interface component electronically communicates a list including the plurality of prices and each operatively associated entry. Each of the plurality of prices is mapped to each operatively associated one of the authorized set of entries and/or one of the selected sets of capable entries. The communication of the list may be done and Extensible Markup Language format (also referred to herein as “XML”).

In yet another embodiment of the present disclosure, the system includes an advanced sourcing workbench. The advanced sourcing workbench includes a vendor user interface, and is in electrical communication with the database and a plurality of vendors selected for sourcing. Each vendor can communicate a vendor preference to the database utilizing the vendor user interface of the advanced sourcing workbench. The vendor preference may be a vendor capability and/or a vendor price corresponding to a vendor job. The predetermined set of criteria, mentioned supra, may be a constraint corresponding to the vendor preference.

The system may also include a document advisor interface including a document-advisor user interface (e.g., a GUI). The document advisor can utilize the document-advisor user interface to review the vendor preference, delete the vendor preference, modify the vendor preference, re-categorize the vendor preference, remove a respective entry of the vendor from the authorized set of entries, authorize the set of entries corresponding to the database of vendors, and/or select the set of capable entries from the database of vendors.

In another embodiment of the present disclosure, the system further includes a workflow optimization component. The workflow optimization component generates a workflow corresponding to the campaign-specification data structure. The workflow includes one or more job units corresponding to a job specification of the campaign-specifications data structure. Two job units may be associated with different entries in the database of vendors. For example, one vendor may be responsible for printing posters, and another vendor may be responsible for shipping the posters to a targeted audience. In this example, these jobs includes may include: (1) printing the posters by vendor A, (2) shipping the posters to vendor B, and (3) shipping the posters to multiple advertising targets by vendor B. The workflow optimization component further includes a workflow optimization user interface configured to receive input from a user to control the generation of the workflow. Additionally or alternatively, the cost optimization component may be to minimize a campaign cost when performing the campaign as operatively specified by the campaign-specifications data structure.

In another embodiment of the present disclosure, the campaign-specification data structure is a container for one or more job specifications. The campaign-specification data structure may include one or more campaign properties. For example, the campaign-specification data structure may be an abstract data type such as an object, which includes an array of pointers adapted to point to one or more job specifications that may also be abstract data types such as objects. One or more campaign properties may be inheritable by the job properties, e.g., a job specification may inherit a campaign property as a job property. Additionally or alternatively, job properties may be dependent on campaign properties. For example, a campaign property of a campaign due date sets a bound on all jobs, thus a job due date is bounded by the campaign due date.

The direct mail campaign catalog may include a card job, an envelope job, a brochure job, and a poster job for job type selection. The direct mail campaign advertising may include a mail preparation, a shipping service, a direct mail targeting service, a market research, a new paper insert service, a campaign results service, and/or a newspaper insert service for job type selection. The newspaper insert service includes at least one job property of at least one of an insert shape property, an object insert property, a shipping requirement property and/or a delivery requirement property. The market research can include one or more job properties of one or more of a media market research service property, an advertising channel property, and/or a geographic scope property. The direct mail non-printable services may include one or more of a legal service, a notary service, a translation service, a file conversion service, a security service, a campaign legal job, and/or a campaign translation job.

In yet another embodiment of the present disclosure, the system further comprises an awards component. The awards component generates an award campaign data structure corresponding to the campaign-specification data structure, wherein the awards campaign data structure includes at least one awarded job unit corresponding to the at least one job specification.

In another embodiment of the present disclosure, a method for processing advertisement campaign requests is provided. The method includes: (1) selecting a job specification associated with a job type selected from a direct mail campaign catalog, a direct mail campaign advertising and a direct mail non-printable service; (2) electronically storing a campaign-specification including the job specification; (3) determining a first set of capable vendors from a predetermined set of vendors, the first set of capable vendors capable of performing a first job of a campaign as operatively specified by the job specification of the campaign-specification; (4) authorizing a second set of vendors selected from the first set, the second set of vendors authorized for bidding on performing the first job of the campaign as operatively specified by the job specification of the campaign-specification; and/or (5) determining a total price corresponding to the campaign-specification including the job specification, wherein a price of the total price corresponds to a vendor in the second set of vendors performing the first job.

### BRIEF DESCRIPTION OF THE DRAWINGS

These and other advantages will become more apparent from the following detailed description of the various embodiments of the present disclosure with reference to the drawings wherein:

FIG. 1 shows a block diagram of a system for processing advertisement campaign requests in accordance with the present disclosure;

FIGS. 2A-2B show a more detailed view of the marketplace of FIG. 1 in accordance with the present disclosure;

FIG. 3 shows the catalog model of the direct mail campaign catalog in accordance with the present disclosure; and

FIG. 4 shows a methodology of processing advertisement campaign requests in accordance with the present disclosure.

### DETAILED DESCRIPTION

Particular embodiments of the present disclosure are described herein below with reference to the accompanying drawings. In the following description, well-known functions or constructions are not described in detail to avoid obscuring the present disclosure in unnecessary detail.

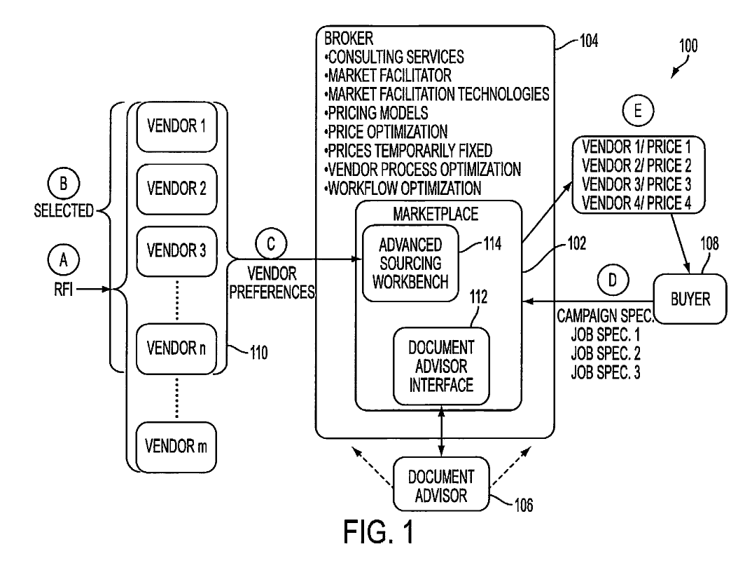

Referring to the drawings, FIG. 1 shows a system 100 for processing advertisement campaign requests in accordance with the present disclosure. System 100 includes a marketplace 102 organized and facilitated by a broker 104. The marketplace 102 may be implemented in hardware, software, software in execution, in virtualization, utilizing CPLDs, PALs, PLDs, one or more servers, firmware, bytecode, microcode, by an operative set of processor executable instructions configured by execution by at least one processor, or some combination thereof. System 100 includes stages A, B, C, D, and E. The stages may occur in serial, in parallel, step-wise, or otherwise in any ordering. The letter designation is only for referencing by the description herein.

Marketplace 102 is organized by broker 104. Broker 104 can provide the marketplace 102 and facilitates transactions. The transactions may be facilitated by broker 104 by providing legal services, the contractual framework, and the market rules and procedures. Broker 104 also provides: (1) consulting services, (2) facilitates the market, (3) provides market facilitation technologies, (4) provides pricing models, (5) optimizes prices, (6) provides the legal framework so that prices are temporarily fixed during the bidding process, (7) provides vendor process optimization services, and (8) optimizes the workflow.

System 100 also includes document advisor 106 (referred to herein as “DA 106”). DA 106 can facilitate price optimization of print and non-print related commodities relating to advertisement campaigns and other print jobs. To conduct large scale enterprise style advertising campaigns, DA 106 procures a broad range of services and goods for buyer 108. These enterprise services may utilize different equipment, consumables, and associated data exchanges. Marketplace 102 enables DA 106 to procure a broader range of services as part of the advertising campaign including job types selected from Direct Mail Campaign type jobs. Rather than having the DA 106 use non-standard tools to store and utilize data to procure various products through non-print market procurement means, which leads to loss of revenue for broker 104, marketplace 102 can facilitate procurement by buyer 108 of various job types related to advertising campaigns including non-print based services related to advertising campaigns. Some of these services may also be offered by broker 104 or may simply be facilitated by broker 104 using marketplace 102.

Some of the jobs required for these goods and services are available for procurement via marketplace by procuring from one of vendors 110. Vendors 110 includes vendor 1 through vendor m (including vendor n). The letter n and m designates that an arbitrary number of vendors are used with n≦m. Some of the services offered by vendors 110 include job types chosen from: direct mail campaign catalogs, direct mail campaign advertising, and direct mail non-printable services, which are provided to buyer 108 along with direct mail campaign services (discussed in more detail below). Advertising services and nonprintable services are therefore deliverable in marketplace 102.

An advertising campaign may be considered as tying together several jobs, e.g., an advertising campaign is a container for multiple jobs. Jobs grouped into a campaign may inherit some properties from the campaign by default which is also discussed in more detail below. Each job may have multiple components as part of the specification. These workflows may be configurable by DA 106 depending upon the information entered via document advisor interface 112.

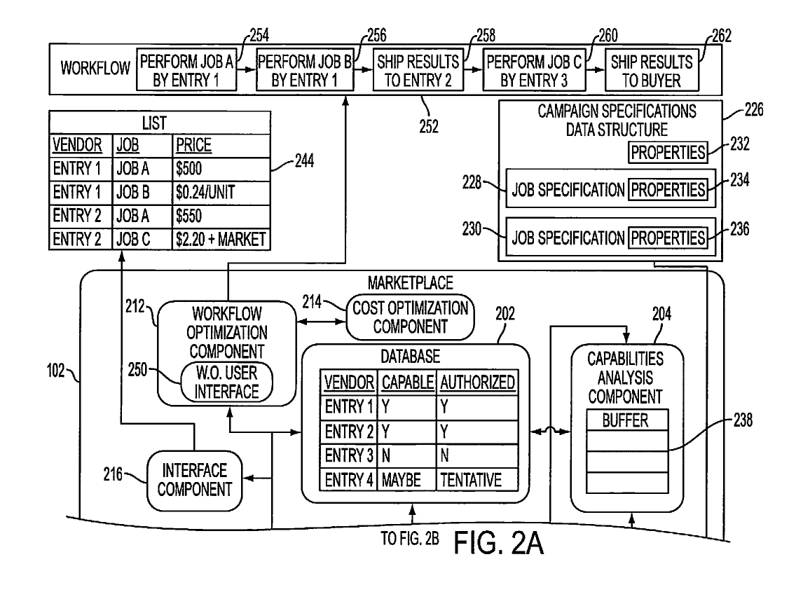

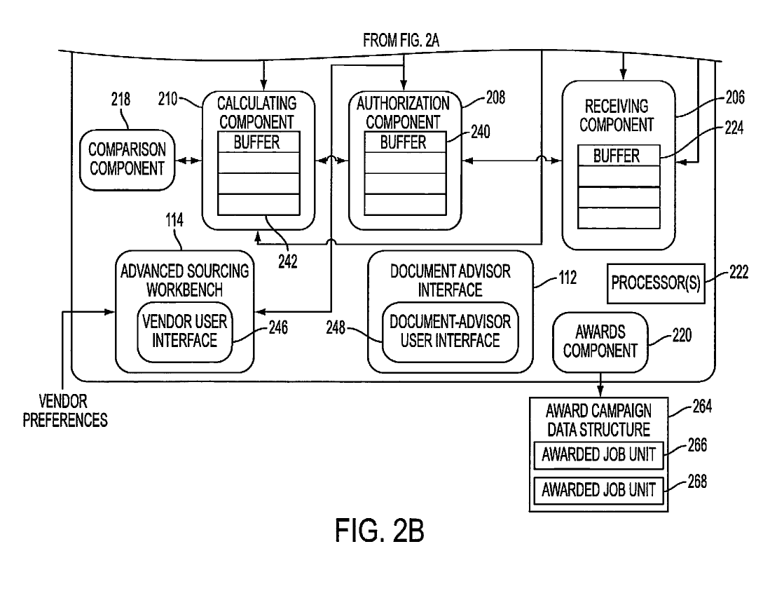

During stage A, requests for information (also referred to herein as “RFIs”) are submitted to vendors 1 through m to elicit information from vendors 110. Stage A may take up to nine months and may involve dozens of support individuals for the case where there are almost 300 vendors within vendors 110. After reviewing RFI submittals, stage B culls vendors 110 to select vendors 1 through n from vendors 110. During stage C, vendors 1 through n of vendors 110 enter vendor preferences including about 2,000 price points into a database 202 (see FIGS. 2A-2B) through advanced sourcing workbench 114. The database 202 is part of marketplace 102. Document advisor 106 may assist vendors 1 through n by reviewing and adjusting information including the vendor preferences, e.g., the price points, utilizing document advisor interface 112. Additionally or alternatively, document advisor 106 may further limit the list of authorized vendors that can participate in marketplace 102 transactions.

During stage D, buyer 108 inputs a campaign-specification data structure, including one or more job specifications, into marketplace 102. The campaign-specification data structure may be in an XML format. XML provides robust communications which may be changed, upgraded, and/or modified to facilitate communications. XML provides a mechanism (such as syntax) so that various computing systems can share information between or within applications, systems, organizations, computing systems and the like. During stage E, marketplace 102 determines which vendors are capable and/or are authorized to perform one or more jobs as specified by the job specifications of the campaign-specifications data structure, and generates a list of vendors capable of producing (or performing) the jobs along with a preview price based on the rates collected during the sourcing effort, e.g., the vendor preferences entered during stage C.

An advertising campaign may have several job types, some of which may be related to additional unique jobs that are required to conduct an effective advertising campaign. For example, advertising campaigns may include several non-printable jobs such as legal and translation services, format conversions, and security services, each one depending upon other unique jobs required to perform those functions in a multi-varied advertising campaign production environment. When buyer 108 generates campaign-specifications data structures including several job specifications, the options are presented to buyer 108 based on the entered configurations and preferences entered into marketplace 102 via vendor preferences and/or via information communicated by document advisor 106.

Referring to FIGS. 2A-2B, a more detailed view of the marketplace 102 of FIG. 1 is shown. Marketplace 102 includes the document advisor interface 112, the advanced sourcing workbench 114, the database 202, a capabilities analysis component 204, a receiving component 206, an authorization component 208, a calculating component 210, a workflow optimization component 212, a cost optimization component 214, a interface component 216, a comparison component 218, and an awards component 218. Marketplace 102 may be implemented utilizing one or more processors 222. Additionally or alternatively, marketplace 102 may utilize one or more memories, e.g., all buffers may be in a single memory or may be distributed among several memories.

Receiving component 206 includes buffer 224. Receiving component 206 electronically receives a campaign specification data structure 226, e.g., via an XML format. Campaign specification data structure 226 includes information to request advertising campaign goods and/or services and includes job specifications 228 and 230. Campaign specifications data structure 226 includes properties 232; and job specifications 228 and 230 include properties 234 and 236, respectively. A property 232 of campaign specification data structure 226 may be inheritable by a property of a job, e.g., a property of properties 234 may inherit from a property of properties 232. Additionally or alternatively, a property of a job specification may be bounded by a property of a campaign specification data structure, e.g., a property of properties 234 may be bound or constrained by a property of properties 232. For example, a campaign property 232 being a campaign due date that sets a bound on all jobs, thus a property 234 of job specification 228 being a job due date is bounded by the campaign due date.

As previously mentioned, the campaign specifications data structure includes job specifications 228 and 230. The job specifications 228 and/or 230 may be associated with a job type. The job types associated with job specifications 228 and/or 230 may be from a direct mail campaign catalog, direct mail campaign advertising and direct mail non-printable services. Although campaign specifications data structure 226 is shown as having two job specifications, i.e., job specifications 228 and 230, campaign specifications data structure 226 may have more job specifications. Each job specification may by associated with a differing job type. Campaign specification data structure 226 may include information identifying requirements or preferences from a buyer for a campaign to be performed. For example, the campaign may involve several jobs which a buyer desires to procure and the buyer may transmit (e.g., via XML) to marketplace 102 describing the job the buyer is trying to procure.

Receiving component 206 receives the campaign specifications data structure 226 to electronically store it within buffer 224. Capabilities analysis component 204 is electronically coupled to receiving component 206. Capabilities analysis component 204 is also electronically coupled to database 202. Database 202 may be a SQL-based database and may include a plurality of vendor entries. Capabilities analysis 204 component includes a buffer 238. Capabilities analysis component 204 operatively and electronically receives the campaign-specifications data structure 226 from buffer 224 of receiving component 206. Capabilities analysis component 204 selects a set of capable entries from the database of vendors 202 and stores the selected set of capable entries in buffer 238. The selected entries from database 202 are vendors capable of performing one or more jobs as specified by campaign specifications data structure 226, e.g., entry 1 may be a vendor capable of performing job specification 228 while entry 3 is a vendor that cannot perform any jobs as specified by campaign specifications data structure 226. Although it is shown that capabilities analysis component 204 indicates a capability flag within database 202, it is considered equivalent for such capability to be indicated within buffer 238, within some other buffer, and/or within memory of marketplace 102.

Authorization component 208 is also electronically coupled to receiving component 206 and to database 202. Authorization component 208 includes buffer 240. Authorization component 208 authorizes a set of entries of the database of vendors 202 conforming to a predetermined set of criteria. The authorized set of entries is stored in buffer 240 and is selected from capable entries and/or from database 202. 100431 Calculating component 210 includes buffer 242. Calculating component 210 electronically calculates a plurality of prices corresponding to campaign-specifications data structure 226 and stores the calculated prices in buffer 242. Each price is the price of a vendor performing a job, a total price from a vendor, a total price of a campaign based upon which vendor or vendors performs the jobs, and/or the price is a preview price based upon information from database 202. Comparison component 218 can determine the lowest price from the plurality of prices associated with the authorized set of entries. The lowest price may be flagged in calculating component 210 and/or may be communicated to a buyer, e.g., via interface component 216.

The prices from calculating component 210 may be communicated to a buyer via interface component 216. In addition, interface component 216 may electronically communicate (e.g., via XML) a list 244. List 244 may show the plurality of prices generated by calculating component 210. Each price may be associated with an entry of database 202 (such as entry 1, which corresponds to a particular vendor). Each price may be mapped to one or more capable and/or authorized entries in database 202 (e.g., via association of being a data structure within list 244). The prices in list 244 may be various prices corresponding to an entry performing a job, one or more entries performing one or more jobs, and/or may be a preview price to start negotiations.

Marketplace 102 may also include advanced sourcing workbench 114 including vendor user interface 246. Vendor user interface 246 may be XML based, graphical user interface based, a client application running on a personal computer, php-based and running on a sever, and the like. Advanced sourcing workbench 114, in communication with database 202, can view or determine which of the vendors have been selected for sourcing. Each vendor that has been selected for sourcing can communicate a vendor preference to database 202 utilizing the vendor user interface 246 of said advanced sourcing workbench 114. The vendor preferences communicated may be vendor capabilities and/or vendor prices corresponding to a vendor job to be performed. These prices may be “rates”, total price, formulae, and the like.

As previously mentioned, authorization component 208 authorizes a set of entries of the database of vendors 202 conforming to a predetermined set of criteria. The predetermined set of criteria may be a constraint corresponding to the vendor preferences. Also, marketplace 102 includes document advisor interface 112 including document-advisor user interface 248. Document-advisor user interface 248 is in electronic communication with a document advisor. The document advisor can utilize the document-advisor user interface to review the vendor preferences submitted to database 202, delete the vendor preferences, modify the vendor preferences, re-categorize the vendor preferences, authorize or de authorize entries in database 202, and select which vendors are capable, e.g., set which vendors are capable of performing a job and/or a campaign.

Marketplace 102 also includes workflow optimization component 212 including workflow optimization user interface 250. Workflow optimization component 212 can generate workflow 252. Additionally or alternatively, workflow optimization user interface 250 can receive input from a user to control the generation workflow 250. Workflow 252 may also be communicated to a buyer and may be associated with a price within list 244. Cost optimization component 214 may optimize workflow 252 to minimize the price a buyer pays to perform a campaign as specified by campaign specifications data structure 226. Cost optimization component 214 and workflow optimization component 212 may work together to generate workflow 252.

Workflow 252 includes job units 254, 256, 258, 260, and 262. Job units may correspond to a job specification 228 or 230, a campaign specifications data structure, and the like. Additionally or alternatively, one of the job units 254, 256, 258, 260 or 262 may link together jobs. For instance, Job unit 254 may be for job A to be performed by entry 1. Job unit 256 may be for job B to be performed by entry 1. Job unit 258 may be to ship the results to entry 2. Job unit 260 may be for entry 3 to perform job C. Job unit 262 may be for entry 3 to ship the results to the buyer. As shown in workflow 252, the workflow may utilize more than one vendor.

Marketplace 102 also includes awards component 220. Awards component 220 generates an award campaign data structure 264 corresponding to campaign-specification data structure 226. Awards campaign data structure 264 includes awarded job units 266 and 268 corresponding to job specifications 228 and 230, respectively.

As mentioned above, job specifications of campaign specification data structure 226 may be a job type selected from a direct mail campaign catalog, a direct mail campaign advertising and direct mail non-printable services. The selectable job types selectable from each of these will now be discussed in more detail below.

Direct Mail Campaign Catalog

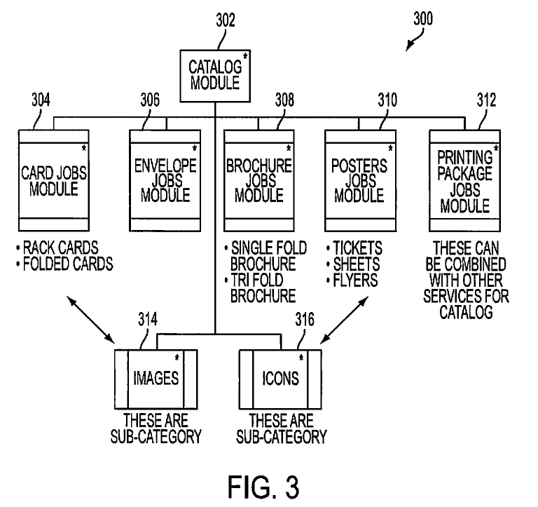

Referring to FIG. 3, direct mail campaign catalog structure 300 is shown. Structure 300 includes catalog module 302, card jobs module 304, envelope jobs module 306, brochure jobs module 308, poster jobs module 310, and printing package jobs module 312. Structure 300 also includes sub categories of images 314 and icons 316. Structure 300 may be a data structure, a database structure, an organization structure, a job type structure, and the like.

For card jobs module 304, the buyer can create one or more card jobs that are specified to be created from a master design or an aggregation of other pieces from the direct mail job that may be processed and/or personalized during the manufacturing process. Multiple card services may also be part of direct mail campaign catalogs that are related to card jobs. Card jobs may include pricing information (or may be considered a type of job) and can include card paper, card ink, aqueous coatings, rack cards, post cards, folded cards and the like. The print type of the cards can be determined by an algorithm for direct mail printing such that optimal print type for the job specification is calculated. The job specification 228 and/or 230 (of FIG. 2) may be created based on paper options, e.g., 120# Gloss Cover or 100# White Cougar Cover. The data collection is done through the sourcing engagement where the Request for Proposal (RFP) is created for each service and a grid is created which is dynamic so that different paper options could be supported during RFP creation.

For the envelope jobs module 306, workflow 252 of FIGS. 2A-2B may be used such that the buyer can create one or more envelope jobs that specify the creation of masters or other pieces for direct mail that will be processed and personalized in the manufacturing process. To source and print envelop jobs, multiple card services may be created. Each service may have single or multiple pricing points. Envelope services may include envelope prepress, envelope press, envelope paper, envelope ink and the like. A software program includes an algorithm that determines an optimal price to be used in direct mail printing as specified by job specifications 228 and/or 230 of FIGS. 2A-2B.

For brochure jobs module 308, workflow 252 of FIGS. 2A-2B may be tailored such that the buyer can create one or more brochure jobs and require the creation of masters or other pieces for the direct mail job that will be processed and personalized in the manufacturing process. To source and price brochure jobs, multiple card services are created. Each service may have single or multiple pricing points. Brochure services include brochure size, brochure paper, brochure ink, aqueous coating, folding, brochure type, single-fold, tri-fold, and the like. A computer application includes a print type determination algorithm to calculate the optimal print type for job specifications 228 and/or 230 of FIGS. 2A-2B. Job specification 228 and/or 230 may correspond to brochure size, paper options, ink, aqueous coating, folding, and the like. Rates for these services are collected through sourcing and an optimum price calculation may correspond to a vendor based on the job specification, e.g., job specifications 228 and/or 230 of FIGS. 2A-2B.

For poster jobs module 310, workflow 252 of FIGS. 2A-2B may be generated such that the buyer can create one or more poster jobs that require the creation of masters or other pieces that will be processed and personalized in the manufacturing process. To source and price poster jobs, multiple card services are created. Each service may have single or multiple pricing points. Poster services include poster paper, posters ink, aqueous coating, poster type, e.g., tickets, sheets and flyers, and the like. A computer application can include a print type determination algorithm that calculates the optimal print type corresponding to job specifications 228 and/or 230. The price calculation may be based on the quantity and the services offered. The catalog component workflow can use multiple components such that the manipulations of catalog products into individual pieces for the distribution process are possible.

Direct Mail Campaign Advertising

The direct mail campaign advertising may include mail preparation, shipping services, direct mail targeting services, market research, newspaper insert services, campaign results services, and newspaper insert services for job type selection. Advertising can utilize mail preparation services and other delivery services to ship advertising materials including post cards, letters, brochures, catalogs, and flyers. Campaign specification data structure 226 of FIGS. 2A-2B may request creative, responsive generation of adverting material. Utilizing a direct mailer assists in targeting the people and businesses most likely to respond, avoids wasting money on sending mail to those you will never hear back from, and achieves a higher return on investment. The direct mail campaign advertising services include a full range of different options suited to meet campaign needs. Direct Mail campaign advertising can be a very cost effective way of advertising, especially if mailings contain printed material. This is due to cost advantages obtained by printing in high volume, since the majority of print costs are realized when a printing machine is initially setup to run a print job and not because of the quantity of material printed. Thus, the total coast of printing 50,000 postcards is only slightly higher than printing 20,000 postcards, but when the total cost is divided by the number of cards printed, the cost per card drops more dramatically as more pieces are printed.

Advertising jobs consist of the following services: market research, newspaper inserts, evaluation of campaign results services, and the like. To be able to model the above, components are used. A newspaper insert component allows the creation of specifications 228 and/or 230 such that capable vendors can have a price preview calculated to give the best possible rates to buyers for different types of the newspaper inserts. When the newspaper insert component is utilized, the following options are available as part of job specifications 228 and/or 230: inserts with different shapes, inserts with different objects (e.g., keys, CDs, coins, stamps), and the like. Shipping and delivery requirements are defined within job specifications 228 and/or 230. A market research component allows specifications 228 and/or 230 to manage the advertising campaign and corresponds to the following services: media market research services (which define the advertising channels) and geographic scope services (which define the scope of the campaign (e.g., international, regional, local), and the like. A campaign evaluation service may be used to measure the results of carrying out the campaign (such as pre-campaign measurement and post-campaign measurement of the customer awareness).

The separate direct mail organization might be created to access vendors with direct mail capability (this could be done on the buying organization level rather than per job level). Vendors can configure different advertising media capabilities. Job optimization can include using the most economical advertising service. If the rates for a service are available, the list of capable vendors for each campaign advertising job within the campaign is generated and the bidding process can start. Campaign functionality may also manage information from each campaign advertising to calculate the best preview price and best vendor. After the bidding process is completed, the buyer can award each individual advertising job contained within the campaign to selected vendors. The campaign modality allows jobs to be split among multiple capable vendors (with the campaign as the “sum of the whole”). Overall, this process will allow buyers (DAs) to include campaign advertising as part of the direct mail campaign in the total print volume they procure for their clients and thereby achieve greater savings.

Direct Mail Non-Printable Services

Direct mail non-printable services also includes several job types giving a buyer the ability to add non-printable services including legal services, notary services, translation services, file conversion services, security services, and the like. To be able to price these services, workflow 252 can include these job types therein. Each workflow may have an associated job type. Direct Mail non-printable services may include job types of campaign legal jobs, campaign translation jobs, and the like. Each of these jobs may have different components.

For legal services, the legal job allows job specifications 228 and/or 230 to facilitate a buyer to “find” capable vendors, display preview prices for each vendor for performing the job, and find the best rates for the copyright services, hourly training services, direct mail notary services, and the like. The pricing for these services could be based on the rate cards rates collected through the sourcing process as well as non rate card pricing based on the capable vendors bid and/or vendor preferences.

The translation services allow the DA to execute the multilingual campaign in a personal, timely, and affordable manner. To be able to create and price the translation services, a direct mail translation component may be used. This component can be defined within job specifications 228 and/or 230. For the direct mail campaigns translation services, the preview price would be calculated based on the vendor rates available through the bidding process. Different pricing models are available based on the vendor preferences including by pricing per lines count, hourly-based prices, and the like.

These aspects of a campaign enhance the business process of the campaign because now buyers have the ability to model and price all activities by creating the campaign specifications data structure 226 starting from the marketing perspectives and to the estimation of the effectiveness of the direct mail campaign.

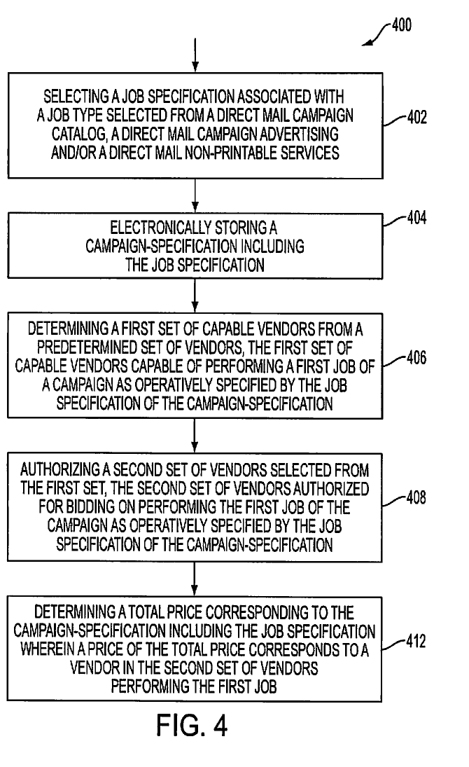

Referring to FIG. 4, a methodology 400 of processing advertisement campaign requests in accordance with the present disclosure is shown. At 402, a job specification associated with a job type is selected from a direct mail campaign catalog, a direct mail campaign advertising and/or a direct mail non-printable services. A campaign-specification including the job specification is then (by way of 404), communicated into electronic storage, e.g., via loading into a buffer. Step 406 determines a first set of capable vendors from a predetermined set of vendors, the first set of capable vendors capable of performing a first job of a campaign as operatively specified by the job specification of the campaign-specification. Step 408 authorizes a second set of vendors selected from the first set. During step 408, the second set of vendors are authorized for bidding on performing the first job of the campaign as operatively specified by the job specification of the campaign-specification. Step 410 determines a total price corresponding to the campaign-specification including the job specification. A price of the total price corresponds to a vendor in the second set of vendors performing the first job.

It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

1. A document-processing system, comprising:
a processor; and
a computer-readable storage medium in communication with said processor, wherein the computer-readable storage medium comprises one or more programming instructions for:
electronically receiving a campaign-specifications data structure including at least one job specification, wherein the at least one job specification is associated with a job type selected from a catalog, an advertising campaign and a mail related service;
selecting a set of entries from a database, wherein each selected entry corresponds to a vendor capable of performing a job as operatively specified by the at least one job specification of the campaign-specifications data structure;
authorizing one or more of the selected set of capable entries in accordance with a predetermined set of criteria; and
calculating a plurality of prices corresponding to the campaign-specifications data structure, wherein each of the plurality of prices is operatively associated with at least one of the one or more of the selected set of capable entries.

2. The system according to claim 1, wherein said one or more programming instructions further comprises generating a workflow corresponding to the campaign-specification data structure, wherein the workflow includes a first job unit corresponding to a first job of the at least one job specification of the campaign-specifications data structure.

3. The system according to claim 2, wherein the workflow includes a second job unit corresponding to a second job of the at least one job specification of the campaign-specifications data structure, wherein the first and second job units are operatively associated with different entries in the database of vendors.

4. The system according to claim 2, further comprising:
a workflow optimization user interface configured to receive input from a user to control the generation of the at least one workflow.

5. The system according to claim 1, further comprising:
an awards component to generate an award campaign data structure corresponding to the campaign-specification data structure, wherein the awards campaign data structure includes at least one awarded job unit corresponding to the at least one job specification.

6. The system according to claim 1, in which the catalog comprises a direct mail campaign catalog and wherein said direct mail campaign catalog includes one of a plurality of job types.

7. The system according to claim 6, wherein the job types comprise a card job type, an envelope job type, a brochure job type, and a poster job type.

8. A computer implemented document-processing system, comprising:
a processing component comprising:
a receiving component adapted for electronically receiving a campaign-specifications data structure including at least one job specification and electronically storing the campaign-specifications data structure, wherein the at least one job specification is associated with a job type selected from a direct mail campaign catalog, a direct mail campaign advertising and a direct mail non-printable service;
a capabilities analysis component for operatively and electronically receiving the campaign-specifications data structure from said receiving component, wherein said capabilities analysis component selects a set of capable entries from a database of vendors and electronically stores the selected set of capable entries, wherein each selected entry corresponds to a vendor capable of performing a first job of a campaign as operatively specified by the at least one job specification of the campaign-specifications data structure;
an authorization component for authorizing one or more of the selected set of capable entries in accordance with a predetermined set of criteria, wherein the one or more of the selected set of capable entries are electronically stored; and
a calculating component for electronically calculating a plurality of prices corresponding to the campaign-specifications data structure, wherein each of the plurality of prices is operatively associated with at least one of the one or more selected set of capable entries.

9. The system according to claim 8, wherein each of the plurality of prices is operatively associated with only one of the authorized set of entries.

10. The system according to claim 8, wherein the authorized set of entries is selected by said authorization component for authorization from only the set of capable entries.

11. The system according to claim 10, wherein at least one of the list and the campaign-specifications data structure are communicated in an Extensible Markup Language format.

12. The system according to claim 8, further comprising:
an advanced sourcing workbench including a vendor user interface, said advanced sourcing workbench in electrical communication with the database and a plurality of vendors selected for sourcing, wherein each vendor communicates a vendor preference to the database utilizing the vendor user interface of said advanced sourcing workbench, wherein the vendor preference is one of a vendor capability and a vendor price corresponding to a vendor job.

13. The system according to claim 8, further comprising:
a workflow optimization component to generate a workflow corresponding to the campaign-specification data structure, wherein the workflow includes a first job unit corresponding to the first job of the at least one job specification of the campaign-specifications data structure.

14. The system according to claim 13, wherein the workflow includes a second job unit corresponding to a second job of the at least one job specification of the campaign-specifications data structure, wherein the first and second job units are operatively associated with different entries in the database of vendors.

15. The system according to claim 13, wherein the workflow optimization component further includes a workflow optimization user interface configured to receive input from a user to control the generation of the at least one workflow.

16. The system according to claim 8, wherein the campaign-specification data structure is a container for the at least one job specification, wherein the campaign-specification data structure includes at least one campaign property.

17. The system according to claim 16, wherein a campaign property of the at least one campaign property is inheritable and a job specification of the at least one job specification inherits the campaign property as a job property.

18. The system according to claim 16, wherein a job specification of the at least one job specification has a job property that is dependent on a campaign property of the at least one campaign property.

19. The system according to claim 8, wherein the direct mail campaign catalog includes a card job, an envelope job, a brochure job, and a poster job for job type selection.

20. The system according to claim 8, wherein the direct mail campaign advertising includes a mail preparation, a shipping service, a direct mail targeting service, a market research, a new paper insert service, a campaign results service, and newspaper insert service for job type selection.

21. The system according to claim 20, wherein the newspaper insert service includes at least one job property of at least one of an insert shape property, an object insert property, a shipping requirement property and a delivery requirement property.

22. The system according to claim 20, wherein the market research includes at least one job property of at least one: a media market research service property, an advertising channel property, and a geographic scope property.

23. The system according to claim 8, wherein the direct mail non-printable services includes at least one of: a legal service, a notary service, a translation service, a file conversion service, a security service, a campaign legal job, and a campaign translation job.

24. The system according to claim 8, wherein the at least one job specification includes two job specifications being associated with different job types.

25. A method for processing documents, comprising:
selecting a job specification associated with a job type selected from a direct mail campaign catalog, a direct mail campaign advertising and a direct mail non-printable service;
electronically storing a campaign-specification including the job specification;
determining a first set of capable vendors from a predetermined set of vendors, the first set of capable vendors capable of performing a first job of a campaign as operatively specified by the job specification of the campaign-specification;
authorizing a second set of vendors selected from the first set, the second set of vendors authorized for bidding on performing the first job of the campaign as operatively specified by the job specification of the campaign-specification; and
determining a total price corresponding to the campaign-specification including the job specification, wherein a price of the total price corresponds to a vendor in the second set of vendors performing the first job.
